(19) United States
(12) Patent Application Publication
(10) Pub. No.: US 2010/0262398 A1
(43) Pub. Date: Oct. 14, 2010

(54) Methods of Selecting Sensors for Detecting Abnormalities in Semiconductor Manufacturing Processes

(75) Inventors: Kye-Hyun Baek, Suwon-si (KR); Yoon-Jae Kim, Seoul (KR); Yong-Jin Kim, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/759,851

(22) Filed: Apr. 14, 2010

(30) Foreign Application Priority Data
Apr. 14, 2009 (KR) 10-2009-0032374

(51) Int. Cl. G06F 19/00

(52) U.S. Cl. 702/121; 702/183

(57) ABSTRACT

A method of selecting a sensor in a semiconductor manufacturing process is provided. The method includes measuring responses of a plurality of sensors when a first of a plurality of process conditions is varied, identifying one or more of the sensors having a steady state response after the first of the process conditions is varied, and selecting a sensor having a highest value within a response range from among the sensors having the steady state response for the first process condition that is varied. This methodology may be performed for multiple different process conditions. Thus, when process conditions in multiple processes of manufacturing a semiconductor device are varied, sensors having a steady state response can be selected from among multiple sensors for detecting abnormalities in the processes.

### CROSS-REFERENCE TO RELATED APPLICATION

This application claims the benefit of priority under 35 U.S.C. §119 from Korean Patent Application No. 10-2009-0032374, filed on Apr. 14, 2009, the entire content of which is incorporated herein by reference in its entirety.

### BACKGROUND

Example embodiments of the present invention relate to semiconductor manufacturing processes and, more particularly, to methods of using sensors that are provided on equipment used in semiconductor manufacturing processes.

During semiconductor manufacturing operations, multiple processes such as deposition, etching, ion implantation, exposure, and cleaning processes may be sequentially or selectively performed on a wafer or substrate. Each of these processes may require equipment such as, for example, a chamber, which provides a processing space where the process is performed.

An example of one such piece of equipment is a plasma etching chamber. Typically, a plasma etching chamber includes a susceptor on which a substrate is placed and to which power is applied from an external source, and an electrode that is disposed above the susceptor and supplied with high-frequency power. Plasma etching chambers may be used generate a plasma atmosphere that may be used to dry etch the substrate at a predetermined etch rate.

A plurality of sensors may be used to monitor a number of different process conditions such as, for example, chamber pressure, chamber temperature, etc. during the processes used to fabricate a semiconductor device. The output of these sensors can be used to detect abnormalities in the equipment. Some semiconductor processing equipment may include well over 100 conventional in-situ sensors. In addition to these conventional in-situ sensors, advanced in-situ sensors such as, for example, optical emission spectrometers (OESs), self excited electron resonance spectrometers (SEERS), voltage-current (VI) probes, etc., may also be mounted in or on the equipment. Moreover, as margins in processing conditions are reduced in order to manufacture higher density semiconductor devices, even larger numbers of sensors may be used in order to monitor very small changes in processing conditions within the chamber in real time.

As the number of sensors is increased, a standardized algorithm for selecting and evaluating the sensors may be used to rank the sensors in order to effectively monitor for abnormalities that occur in the chamber. Conventionally, a multivariate analysis method such as a principal component analysis (PCA) or a partial least squares (PLS) methodology has been used to select and evaluate sensors. While these methods can secure a weight between the sensors, the measured results may vary according to the data standardizing method because physical scales are different from one another due to variation of the process conditions. By way of example, an OES sensor measures emission intensity, whereas a VI probe sensor measures voltage, current, and phase. Thus, these sensors have different physical scales. As a result, the values measured by the sensors vary according to the data standardizing method for applying the PCA, so that the sensors have different weights.

### SUMMARY

Example embodiments provide a method of selecting a sensor in which, when process conditions in multiple processes of manufacturing a semiconductor device are varied, sensors having a steady state response are selected for detecting abnormalities in the processes.

Example embodiments also provide a method of selecting a sensor in a semiconductor manufacturing process, in which, when one of the sensors is selected for multiple process conditions, another sensor in the steady state and capable of alternating for the selected sensor may be selected as an alternative sensor.

Example embodiments also provide a method of selecting a sensor in a semiconductor manufacturing process, in which an atmosphere where process conditions are varied in real time is accurately detected, thereby improving the quality of a manufactured semiconductor device.

In example embodiments, methods of selecting one of a plurality of sensors that are used in a semiconductor manufacturing process are provided. Pursuant to these methods, the responses of a plurality of sensors are measured when a first of a plurality of process conditions are varied. One or more of the plurality of sensors are identified that have a steady state response after the first of the process conditions is varied. A sensor having a highest value within a response range is selected from among the sensors having the steady state response for the first process condition that is varied.

In example embodiments, measuring the responses of the plurality of sensors when a first of the plurality of process conditions is varied may comprise setting numerical criteria for the sensors when the first process condition is varied in order to determine the steady state response, varying the first process condition at a predetermined level, and measuring the response of each sensor.

In example embodiments, identifying the one or more of the plurality of sensors that have a steady state response after the first of the process conditions is varied may comprise setting a signal data interval, in which signal data falls within a predetermined amplitude range, to an analysis interval, the signal data being composed of values of signals generated from the sensors with the lapse of time after the first of the process conditions is varied, smoothing the signal data within the analysis interval using Formula (1), calculating smoothing values of the sensors from the smoothed signal data using Formula (2), calculating a range of the smoothing values of the sensors from the smoothed signal data using Formula (3), calculating numerical criteria of smoothing absolute values of the sensors from the smoothed signal data using Formula (4), identifying the sensors in which the range of the smoothing values is less than the numerical criteria as the sensors having the steady state response, and arranging the identified sensors in descending order of the responses for the first process condition, where Formulas (1), (2), (3) and (4) are as follows:

$${y}_{i , n} = \frac{( {x}_{i , n + 2} + {x}_{i , n + 1} + {x}_{i , n} )}{3} \qquad ( 1 )$$

where, x_{i,n} is the signal value of the i^{th} sensor at a point in time n, and y_{i,n} is the averaged signal value of the i^{th} sensor,

$$\begin{matrix}{y}_{i} = \{ {y}_{n} , … , {y}_{m} \} & ( 2 ) \\ {Range}_{i} = Max ( {Y}_{i} ) - Min ( {Y}_{i} ) & ( 3 ) \\ Numerical {Criteria}_{i} = \vert {\sum }_{j}^{n} \frac{{y}_{j}}{n} \vert \times ( \% xdev . ) & ( 4 )\end{matrix}$$

where, % xdev. is the constant.

In example embodiments, arranging the identified sensors in descending order of the responses for the first process condition may comprise calculating the signal data into a standardized value [symbol] using Formula (5), calculating integrated square response (ISR) within an interval where the first process condition is varied using Formula (6) with respect to a standardized signal value just before the first process condition is varied, and calculating the response and the gain using Formula (7) to arrange the selected sensors in descending order of the responses for the first process condition, where Formulas (5), (6) and (7) are as follows:

$${y}^{*} = \frac{( {y}_{+} ( t ) - {y}_{ss} )}{{y}_{ss}} \qquad ( 5 )$$

where, yₛₛ is the average value of the signal values just before the first process condition is varied, and y₊(t) is the signal value after the first process condition is varied,

$$ISR = \frac{1}{b - a} {\int }_{a}^{b} {( y ( t ) )}^{* 2} d t \qquad ( 6 )$$

where, a is the time when the variation of the first process condition is started, and b is the time when the variation of the first process conditions is completed.

$$Response ( \% ) = \sqrt{ISR} \times 100 , \% Gain = \frac{Response ( \% )}{Step Change ( \% )} \qquad ( 7 )$$

where, Step Change is the variation in the first process condition.

In example embodiments, selecting a sensor having the highest value within a response range from among the sensors having the steady state response for the first process condition that is varied may comprise selecting a sensor having the highest value within the response range from among the sensors arranged in descending order of the responses for the first process condition.

In example embodiments, the method may further include measuring responses of at least some of the plurality of sensors when additional of the plurality of process conditions are varied, identifying ones of the plurality of sensors that have a steady state response after the additional process conditions are varied; and selecting one of the plurality of sensors that has the highest value within a response range from among the sensors having the steady state response for each additional process condition that is varied. In these embodiments, after the sensors are selected for the first and each additional processing condition, another sensor having a relative gain value within a predetermined range may be selected as an alternate sensor for each process condition for which the selected sensor was also selected for additional process conditions.

In example embodiments, selecting the alternative sensor may include setting a range of a reference relative gain value, determining whether or not the selected sensor was selected for multiple process conditions and, if so, arranging the sensors other than the sensor that was selected for multiple process conditions in order of the responses for each process condition, forming a gain matrix based on the gain with respect to the sensors arranged in order of their responses for each process condition, performing one of a relative gain array (RGA) analysis and a non-square relative gain array (NRGA) analysis with respect to the gain matrix to calculate a relative gain value, determining whether or not the calculated relative gain value falls within the reference relative gain value range, and selecting the sensors in which the calculated relative gain value falls within the reference relative gain value range as the alternative sensors.

In example embodiments, the relative gain array (Λ) may be given by Formula (10), and the gain matrix of n×n may be calculated using Formula (11), the non-square relative gain array (Λ″) may be given by Formula (15), and the gain matrix of m×n may be calculated using Formula (16), and in the non-square relative gain array, one of sums of a column and a row may have a value between 0 and 1, and λ may be the sensor,

$$\begin{matrix}Λ = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & ⋯ & {λ}_{( n - 1 ) ( n - 1 )} & {λ}_{( n - 1 ) n} \\ {λ}_{n 1} & {λ}_{n 2} & ⋯ & {λ}_{n ( n - 1 )} & {λ}_{nn}\end{matrix} \vert & ( 10 ) \\ Λ = G ⊗ {( {G}^{- 1} )}^{T} & ( 11 )\end{matrix}$$

where, G is the gain matrix,

$$\begin{matrix}{Λ}^{″} = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & ⋯ & {λ}_{( n - 1 ) ( n - 1 )} & {λ}_{( n - 1 ) n} \\ {λ}_{n 1} & {λ}_{n 2} & ⋯ & {λ}_{n ( n - 1 )} & {λ}_{nn}\end{matrix} \vert \begin{matrix}0 \leq rs ( 1 ) \leq 1 \\ 0 \leq rs ( 2 ) \leq 1 \\ ⋮ \\ 0 \leq rs ( m - 1 ) \leq 1 \\ 0 \leq rs ( m ) \leq 1\end{matrix} \\ cs ( j ) = 1 for all js & ( 15 ) \\ {Λ}^{″} = G ⊗ {( {G}^{+} )}^{T} & ( 16 )\end{matrix}$$

where, G is the gain matrix, and G⁺ is the Moore-Penrose pseudo-inverse matrix of G.

### BRIEF DESCRIPTION OF THE DRAWINGS

Example embodiments are described in further detail below with reference to the accompanying drawings. It should be understood that various aspects of the drawings may be exaggerated for clarity.

FIG. 1 illustrates an example of a semiconductor manufacturing apparatus to which the methods of sensors according to embodiments of the present invention may be applied.

FIGS. 2A and 2B are graphs showing one example of response results measured by sensors before and after variation in process conditions.

FIGS. 3A and 3B are graphs showing another example of response results measured by sensors before and after variation in process conditions.

FIGS. 4A and 4B are graphs showing yet another example of response results measured by sensors before and after variation in process conditions.

FIG. 5A is a graph showing an example where the response of a sensor is measured when process conditions are varied.

FIG. 5B is a graph showing an example where the response of a sensor is not measured when process conditions are varied.

FIG. 6 is a graph showing how an analysis interval is set that may be used in identifying sensors that have a steady state response.

FIG. 7A-FIG. 7F are tables showing responses measured by sensors when process conditions are varied.

FIG. 8 is a table showing a list of sensors that were identified as sensors that have a steady state response.

FIG. 9A is a graph showing that an analysis interval is set in response results of sensors having a non-steady state response.

FIG. 9B is a graph showing that an analysis interval is set in response results of sensors having a steady state response.

FIG. 10 graphically illustrates a process of standardizing signal data of responses of sensors in accordance with example embodiments.

FIG. 11 is a graph showing an example of calculated ISR according to example embodiments.

FIG. 12 is a table showing a result of arranging sensors in order of responses when process conditions are varied.

FIG. 13A-FIG. 13G are tables showing a result of arranging sensors selected under seven process conditions.

FIG. 14 is another table showing a result of arranging selected sensors under seven process conditions.

FIG. 15 is a table showing a gain matrix formed from the table of FIG. 14.

FIG. 16 shows that alternative sensors may be selected by performing a NRGA analysis of the gain matrix of FIG. 15.

FIG. 17 is a flowchart showing one example of a method of selecting a sensor in a semiconductor manufacturing process according to example embodiments.

FIG. 18 is a flowchart showing another example of a method of selecting a sensor in a semiconductor manufacturing process according to example embodiments.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, steps, operations, and/or elements, but do not preclude the presence or addition of one or more other features, steps, operations, elements, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

A method of selecting a sensor in a semiconductor manufacturing process according to example embodiments will be described below with reference to the attached drawings. The sensor may be selected to facilitate identifying abnormalities during the manufacturing process.

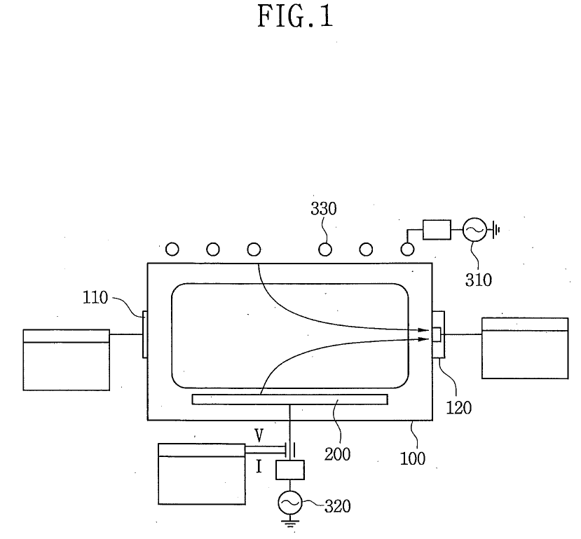

FIG. 1 illustrates one example of a plasma etching apparatus in which methods according to embodiments of the present invention may be applied. As shown in FIG. 1, the plasma etching apparatus comprises a chamber 100 that includes a space for plasma treatment of a substrate (not shown), an inlet 110 on one side of the chamber 100 through which the substrate may be loaded, an outlet 120 on the other side of the chamber 100 through which the substrate may be unloaded after the plasma treatment, a susceptor 200 on which the substrate may be placed in the chamber 100, a power supply 320 that is configured to supply power to the susceptor 200, and an electrode 330 disposed on an upper portion of the chamber 100 and supplied with power from a high-frequency power supply 310. The plasma etching apparatus of FIG. 1 may be used to etch a substrate using plasma formed in the plasma treatment space of the chamber 100.

The plasma etching apparatus of FIG. 1 may further include a plurality of in-situ sensors such as, for example, optical emission spectrometers (OESs), self excited electron resonance spectrometers (SEERSs), voltage-current (VI) probes, etc. These sensors may be used to monitor conditions within the chamber in real time while a process is carried out in the chamber 100.

Pursuant to one example embodiment of the present invention, the sensors associated with the plasma etching apparatus of FIG. 1 may be monitored in order to select sensors that are used to detect any abnormalities that arise when the apparatus is used in a plasma etching process.

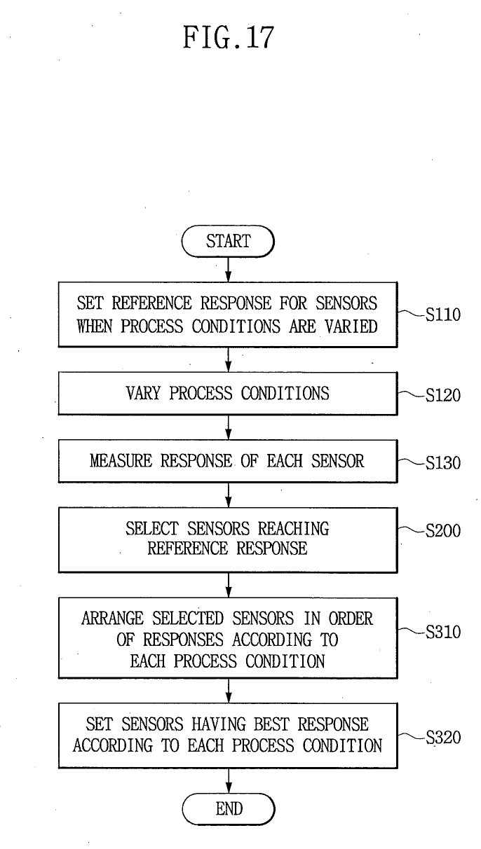

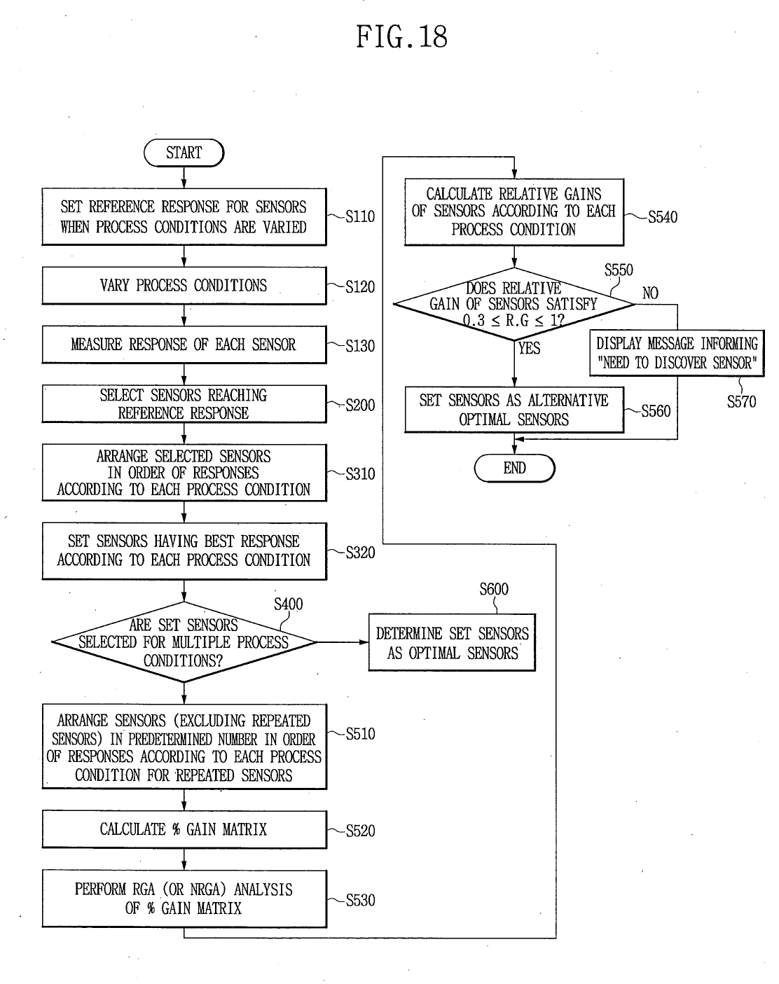

Referring to FIGS. 17 and 18 (which are discussed in more detail below), it can be seen that a method of selecting a sensor in a semiconductor manufacturing process according to example embodiments includes measuring the responses of multiple sensors when process conditions are varied, identifying at least one sensor that has a steady state response from among the sensors, and selecting at least one sensor having a highest value within a response range according to each process condition from among the identified sensors having the steady state response.

After a sensor is selected, the method may further include, selecting another sensor having a relative gain value within a predetermined range from among the non-selected sensors as an alternative sensor.

The method outlined in FIGS. 17 and 18 will now be discussed in greater detail.

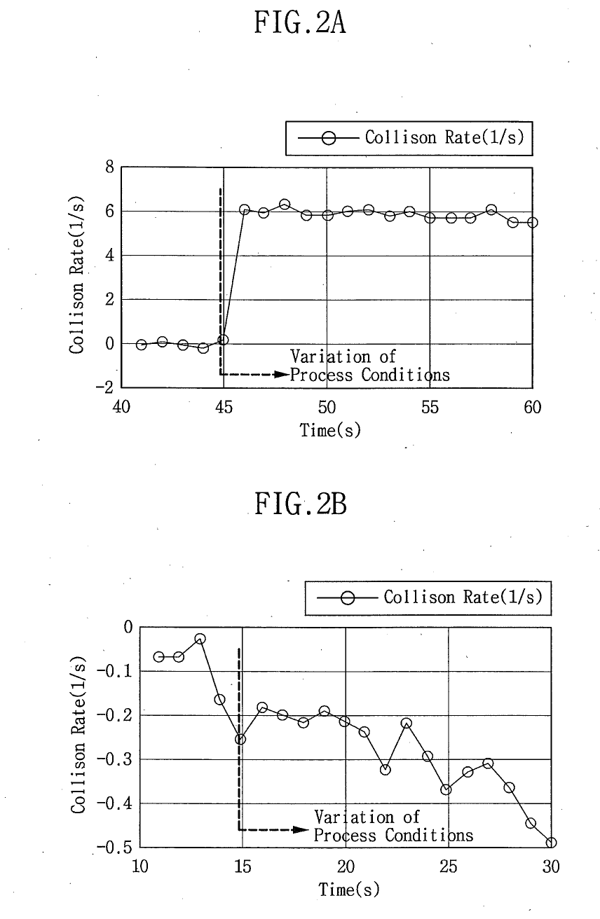

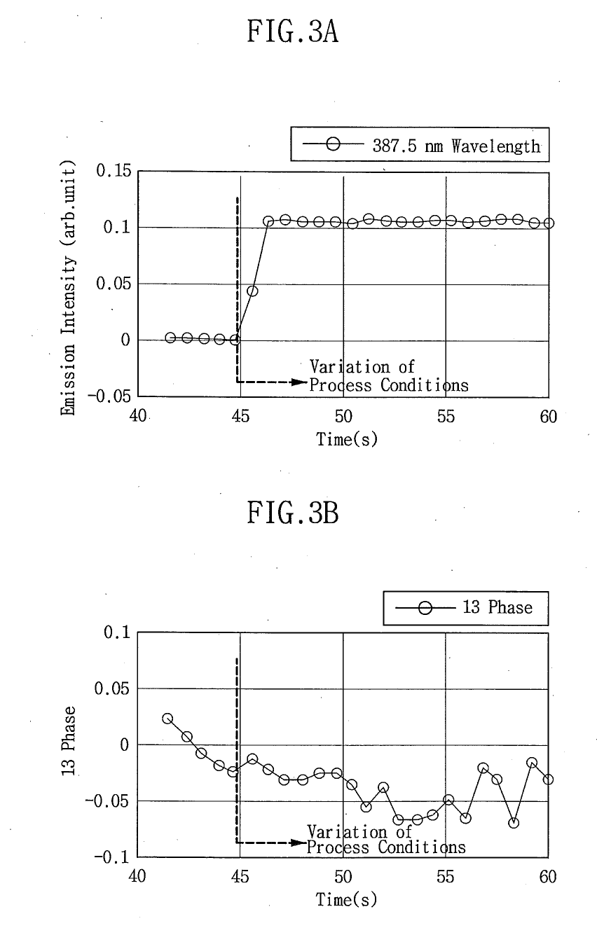

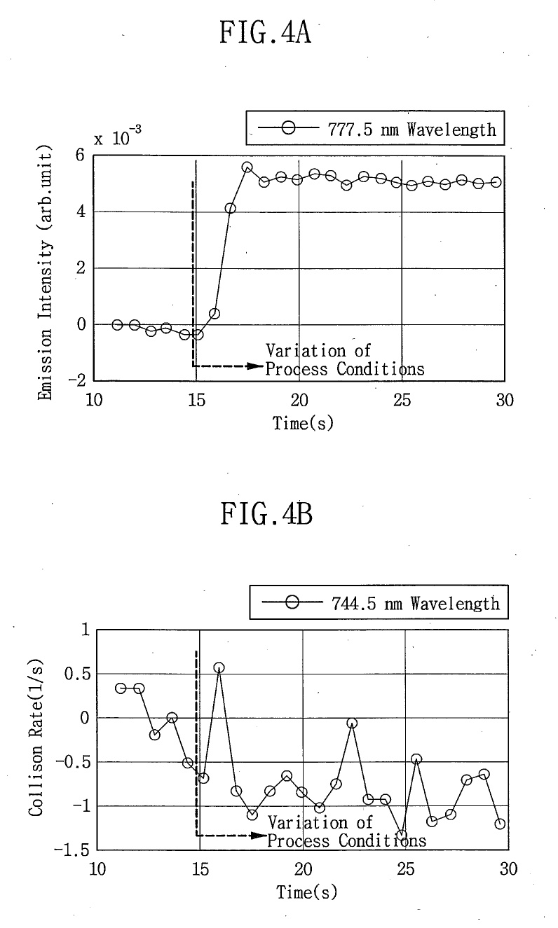

FIGS. 2A and 2B are graphs showing an example of response results measured by sensors before and after variation in process conditions. FIGS. 3A and 3B are graphs showing another example of response results measured by sensors before and after variation in process conditions. FIGS. 4A and 4B are graphs showing yet another example of response results measured by sensors before and after variation in process conditions.

As shown in FIG. 17, in measuring responses of multiple sensors, a reference response of the sensors in response to a variation in process conditions is set to determine the steady state response (S110). Each process condition may then be varied to a predetermined level (S120). As each process condition is varied, the response of each sensor is measured (S130).

In FIGS. 2A and 2B, the responses measured by the sensors before and after the variation of the process conditions are shown as “strong responses.” Specifically, in FIG. 2A, the responses of the sensors remain relatively constant over time after the variation of the process conditions. Thus, the responses of the sensors may be considered to be steady state responses. On the other hand, in FIG. 2B, the responses of the sensors do not remain constant over time after the variation of the process conditions. Thus, the responses of the sensors shown in FIG. 2B are not steady state responses.

In FIGS. 3A and 3B, the responses measured by the sensors before and after the variation of the process conditions are shown as “moderate responses.” Specifically, FIG. 3A shows that the responses of the sensors remain relatively constant over time after the variation of the process conditions. Thus, the responses of the sensors may be considered to be steady state responses. On the other hand, in FIG. 3B, the responses of the sensors do not remain constant over time after the variation of the process conditions. Thus, the responses of the sensors shown in FIG. 3B are not steady state responses.

In FIGS. 4A and 4B, the responses measured by the sensors before and after the variation of the process conditions are shown as “weak responses.” Specifically, FIG. 4A shows that the responses of the sensors remain relatively constant over time after the variation of the process conditions. Thus, the responses of the sensors may be considered to be steady state responses. On the other hand, in FIG. 4B, the responses of the sensors do not remain constant over time after the variation of the process conditions. Thus, the responses of the sensors shown in FIG. 4B are not steady state responses.

As mentioned above, the sensors having the steady state response are identified. In other words, the sensors having the reference response are identified (block S200 in FIG. 17).

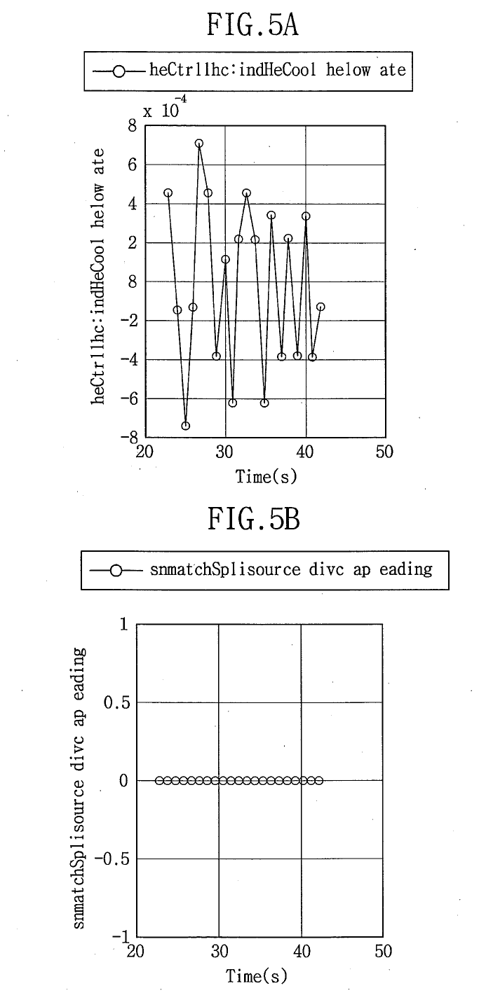

FIG. 5A is a graph showing an example where the response of a sensor is measured when process conditions are varied. FIG. 5B is a graph showing an example where the response of a sensor is not measured when process conditions are varied.

Here, referring to FIGS. 5A and 5B, after the process conditions are varied, the responses of some of the sensors are measured, while the responses of others of the sensors may not be measured.

Now, a process according to example embodiments of the present invention will be described for identifying sensors that have a steady state response after process conditions are varied.

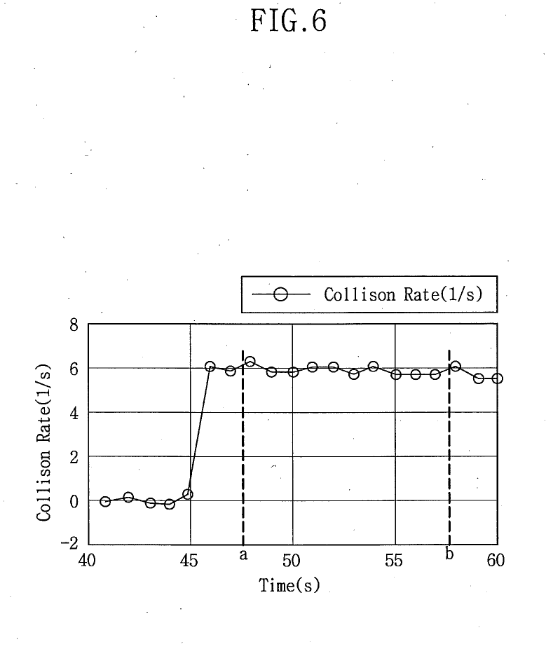

FIG. 6 is a graph showing how an analysis interval [a, b] may be set that may be used in identifying the sensors that have a steady state response.

In identifying sensors that have a steady state response, among signal data composed of values of signals generated from the sensors with the lapse of time after the process conditions are varied, a signal data interval that falls within the range of a predetermined amplitude is set to an analysis interval [a, b]. Then, a moving average of the signal values of the sensors within the analysis interval [a, b] is obtained using the following method.

$${y}_{i , n} = \frac{( {x}_{i , n + 2} + {x}_{i , n + 1} + {x}_{i , n} )}{3} \qquad ( 1 )$$

where x_{i,n} is the signal value of the i^{th} sensor at a point in time n, and y_{i,n} is the averaged signal value of the i^{th} sensor. Thus, Formula (1) may be used to smooth the signal data within the analysis interval [a, b].

Next, the range and numerical criteria of smoothing values may be determined using the following formulas:

$$\begin{matrix}{y}_{i} = \{ {y}_{n} , … , {y}_{m} \} & ( 2 ) \\ {Range}_{i} = Max ( {Y}_{i} ) - Min ( {Y}_{i} ) & ( 3 ) \\ Numerical {Criteria}_{i} = \vert {\sum }_{j}^{n} \frac{{y}_{j}}{n} \vert \times ( \% xdev . ) & ( 4 )\end{matrix}$$

In particular, Formula (2) is used to calculate smoothing values of the sensors from the smoothed signal data, and Formula (3) is used to calculate a range of the smoothing values of the sensors. Further, percent values, i.e. numerical criteria, of smoothing absolute values of the sensors are calculated from the smoothed signal data using Formula (4), where % xdev. is a constant, and may be twice a variable rate of the process conditions of the equipment. % xdev. is a term which a worker can input externally through a separate input unit.

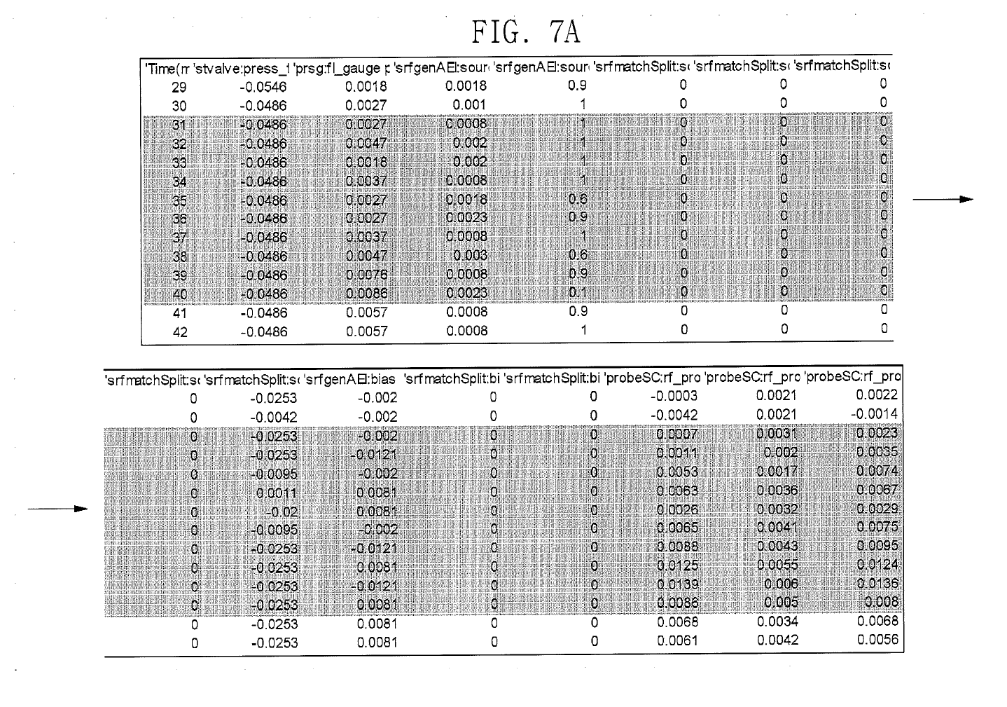

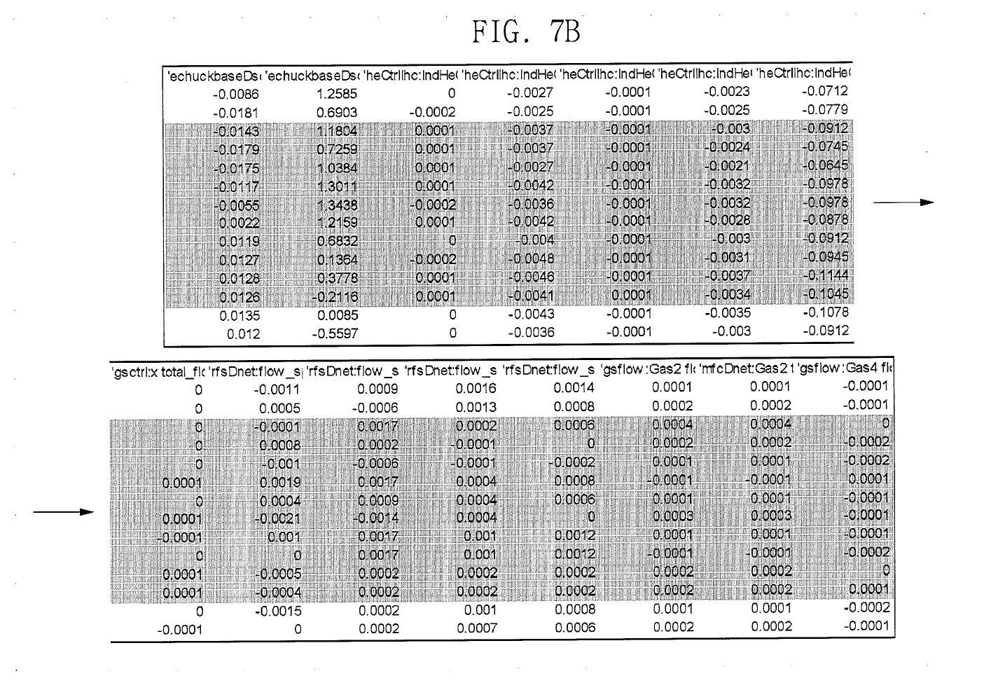

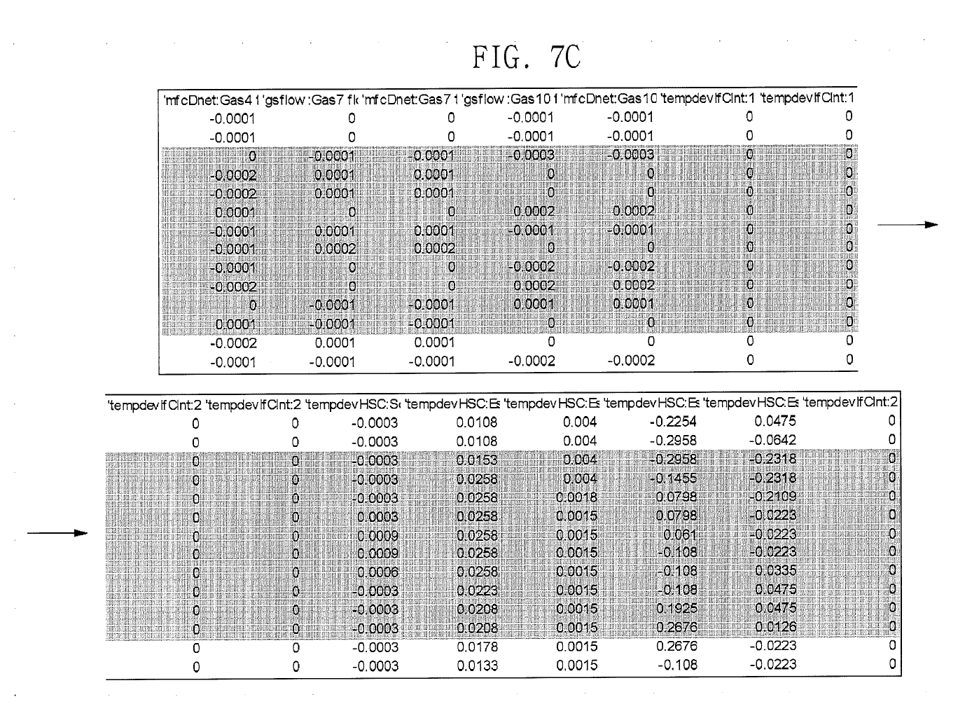

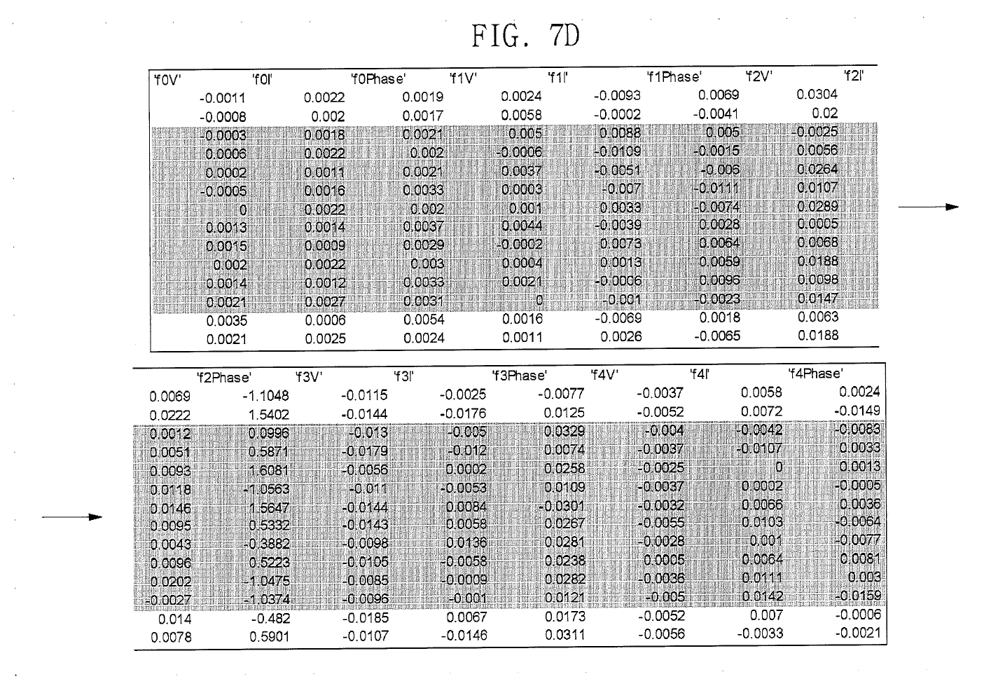

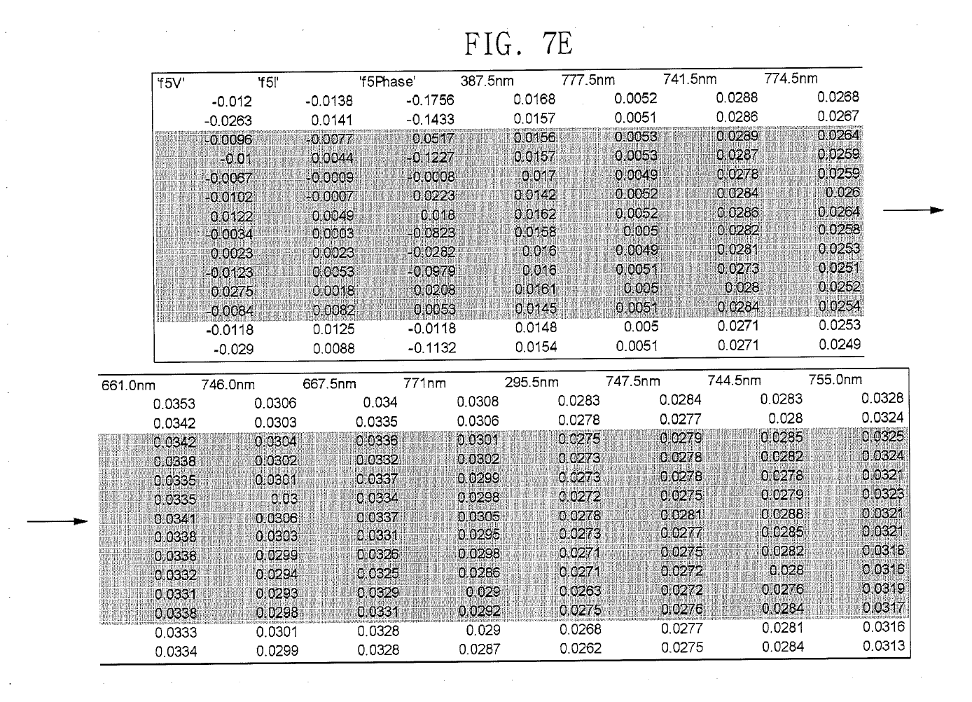

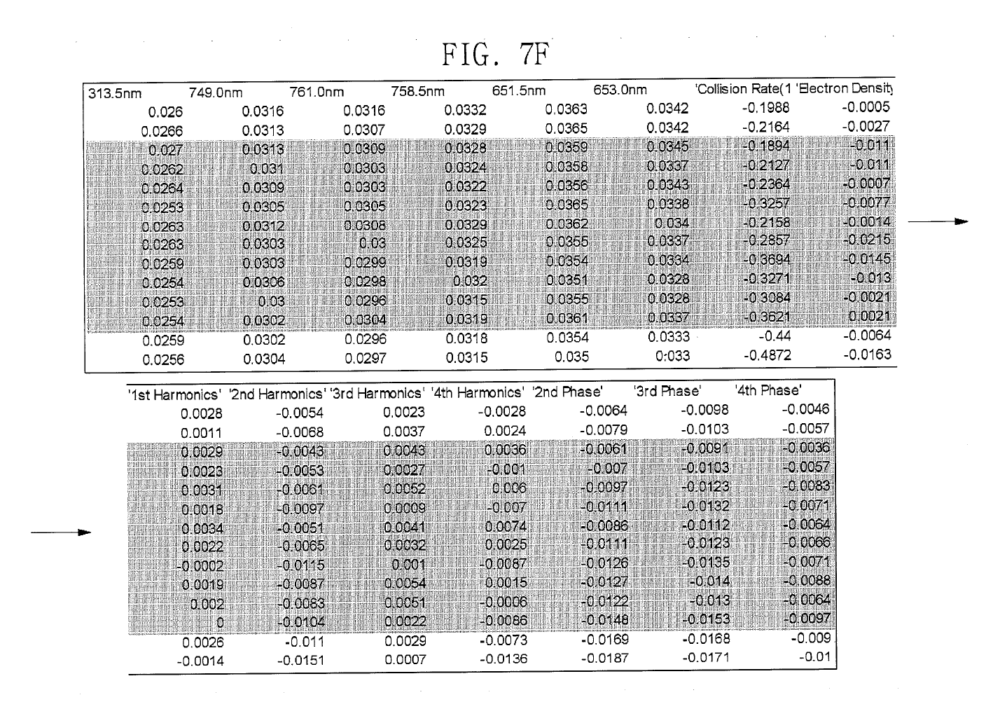

FIG. 7A-FIG. 7F are tables showing responses measured by sensors when process conditions are varied. The sensors in FIG. 7A-FIG. 7F in which the range of the smoothing values is less than the numerical criteria are identified as sensors having a steady state response.

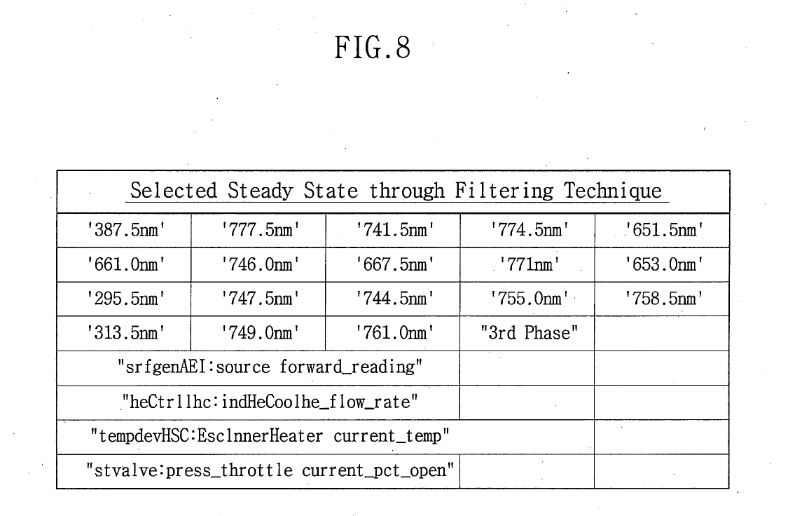

FIG. 8 is a table showing a list of sensors identified as sensors having a steady state response. All of the sensors that have a non-steady state response may be removed.

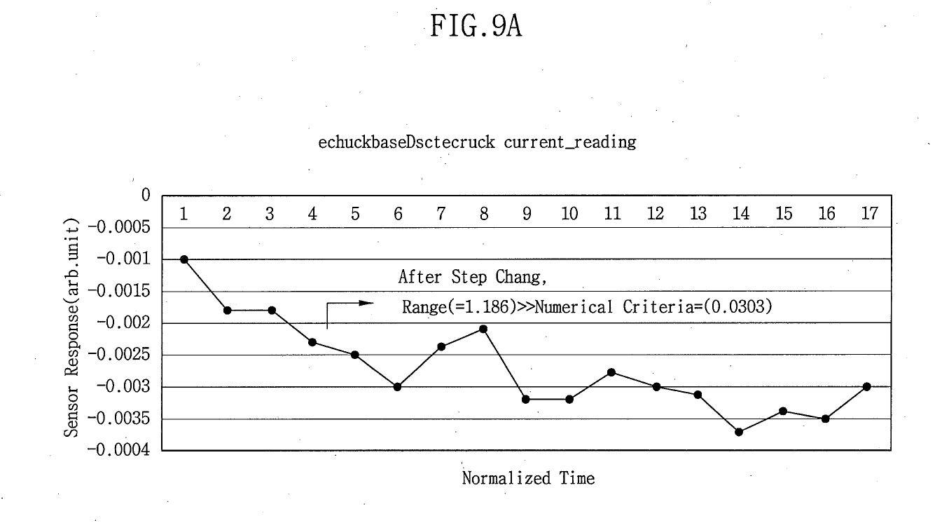

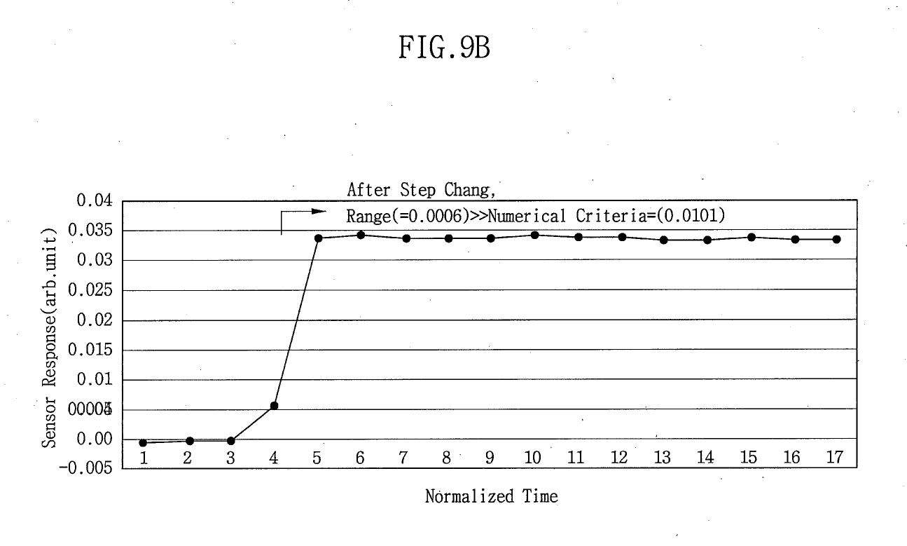

FIG. 9A is a graph showing that an analysis interval is set in response results of sensors having a non-steady state response. FIG. 9B is a graph showing that an analysis interval is set in response results of sensors having a steady state response.

FIG. 9A shows an example where the range of the smoothing values is more than the numerical criteria. Accordingly, the sensors in the example of FIG. 9A are classified as the sensors having a non-steady state response. FIG. 9B shows an example where the range of the smoothing values is less than the numerical criteria. Accordingly, the sensors in the example of FIG. 9B are classified as the sensors having a steady state response. Thus, according to example embodiments, it can be seen that the results obtained by comparing the range of the smoothing values with the numerical criteria have at least a predetermined margin in making a distinction between sensors having a steady state response and sensors having a non-steady state response.

Subsequently, the identified sensors are arranged in descending order of the responses according to each process condition (S310). In other words, the sensors having the steady state response are ranked on the basis of the numerical criteria.

First, when the identified sensors are arranged in descending order of the responses according to each process condition, a standardized value is calculated.

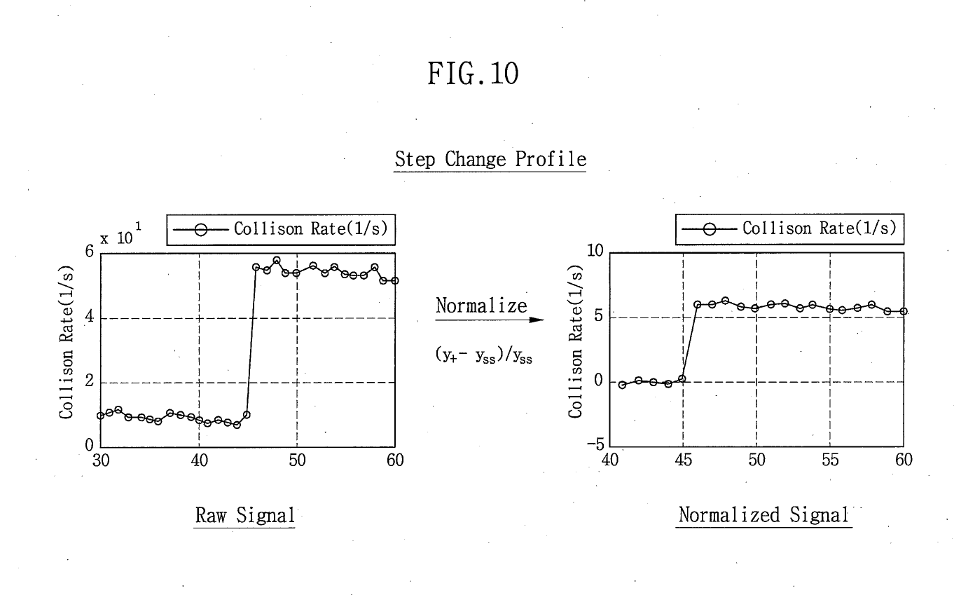

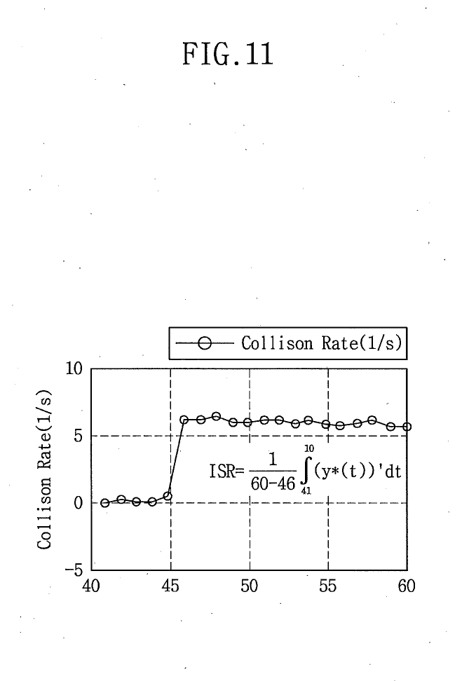

FIG. 10 graphically shows a process of standardizing signal data of responses of sensors in accordance with example embodiments.

$${y}^{*} = \frac{( {y}_{+} ( t ) - {y}_{ss} )}{{y}_{ss}} \qquad ( 5 )$$

where yₛₛ is the average value of the signal values just before the process conditions are varied, and y₊(t) is the signal value after the process conditions are varied. The signal data shown in the graph on the left hand side of FIG. 10 is calculated into a standardized value [symbol] shown on the right hand side of FIG. 10 using Formula (5).

Next, an integrated square response (ISR) is calculated using Formula (6):

$$ISR = \frac{1}{b - a} {\int }_{a}^{b} {( {y}^{*} ( t ) )}^{2} d t \qquad ( 6 )$$

Specifically, with respect to a standardized signal value just before the process conditions are varied, the ISR is calculated within an interval where the process conditions are varied using Formula (6). In other words, with respect to the signal value standardized by a signal value point just before the process conditions are varied, “Time-integrated Square Square Sum” is obtained within an interval after the process conditions are varied. In Formula (6), “a” is the time when the variation of the process conditions is started, and “b” is the time when the variation of the process conditions is completed.

Next, the response and the gain are calculated using Formula (7):

$$Response ( \% ) = \sqrt{ISR} \times 100 , \\ \% Gain = \frac{Response ( \% )}{Step Change ( \% )} \qquad ( 7 )$$

In Formula (7), Step Change is the process condition variation. After the responses are calculated using Formula (7), the identified sensors are arranged in descending order of the responses according to each process condition.

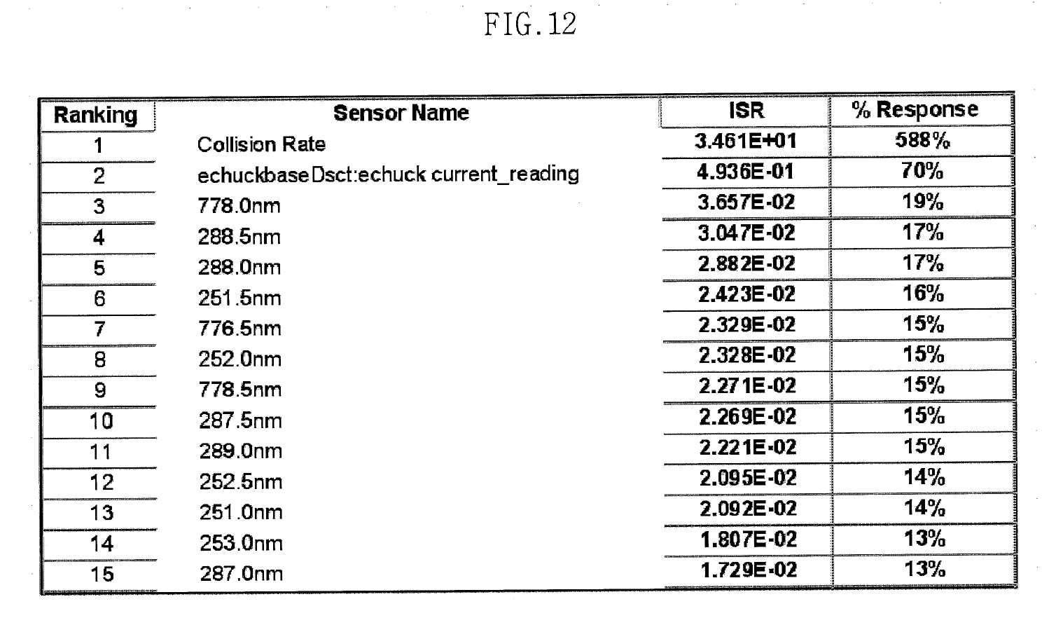

FIG. 12 shows calculated ISRs according to example embodiments, and a result of ranking sensors when process conditions are varied. In FIG. 12, both the responses and the gains of the sensors were calculated using Formula (7).

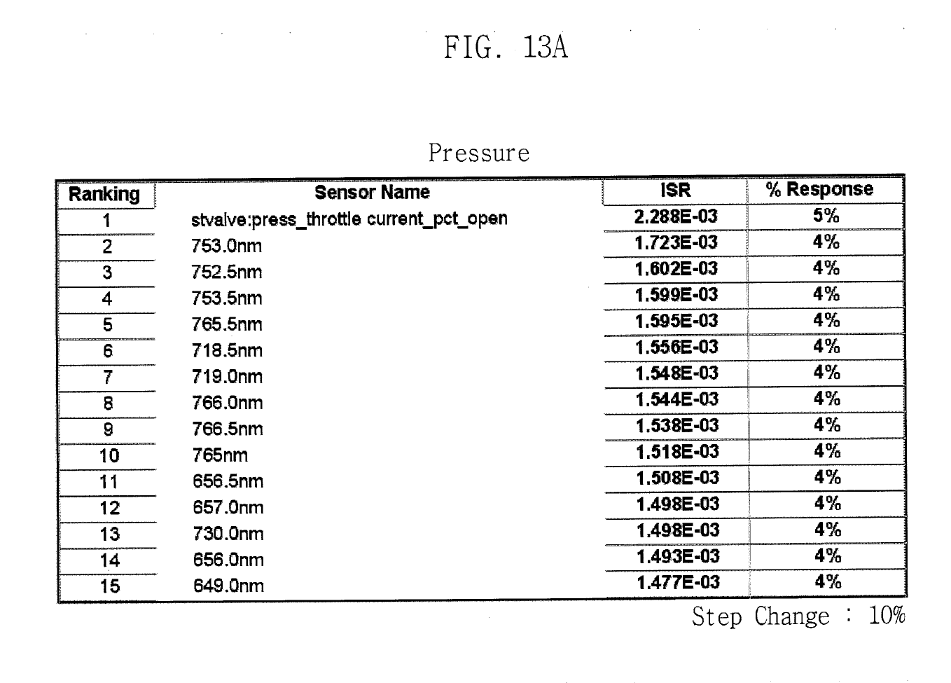

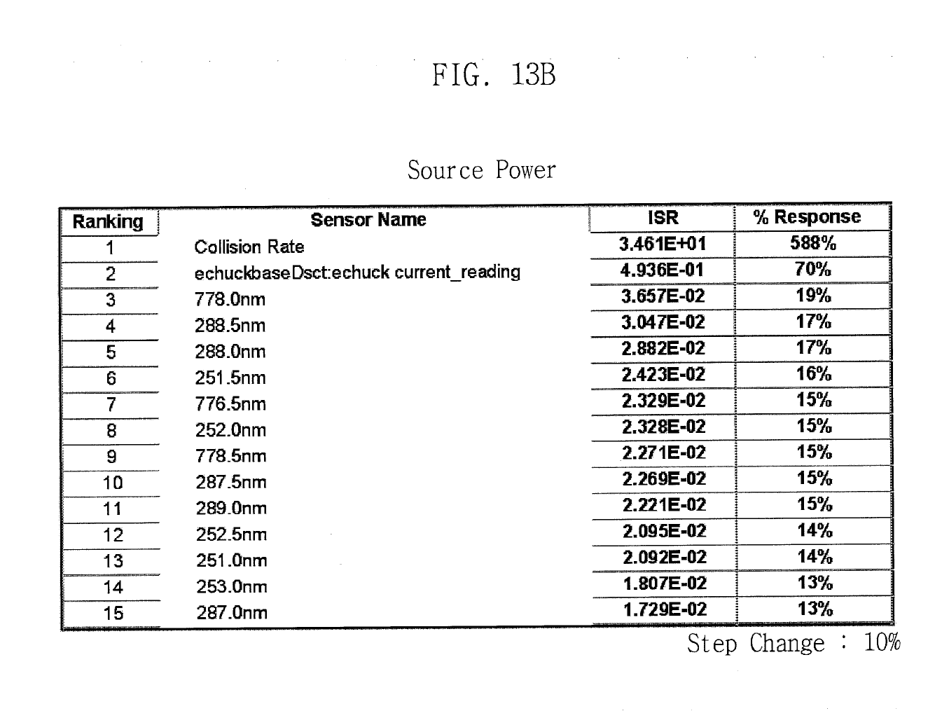

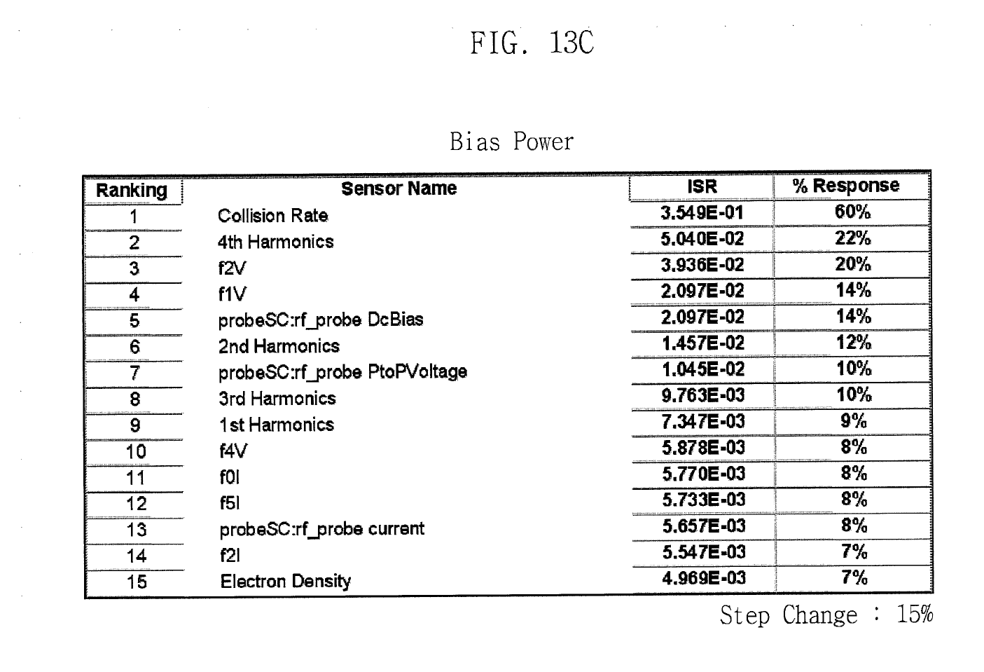

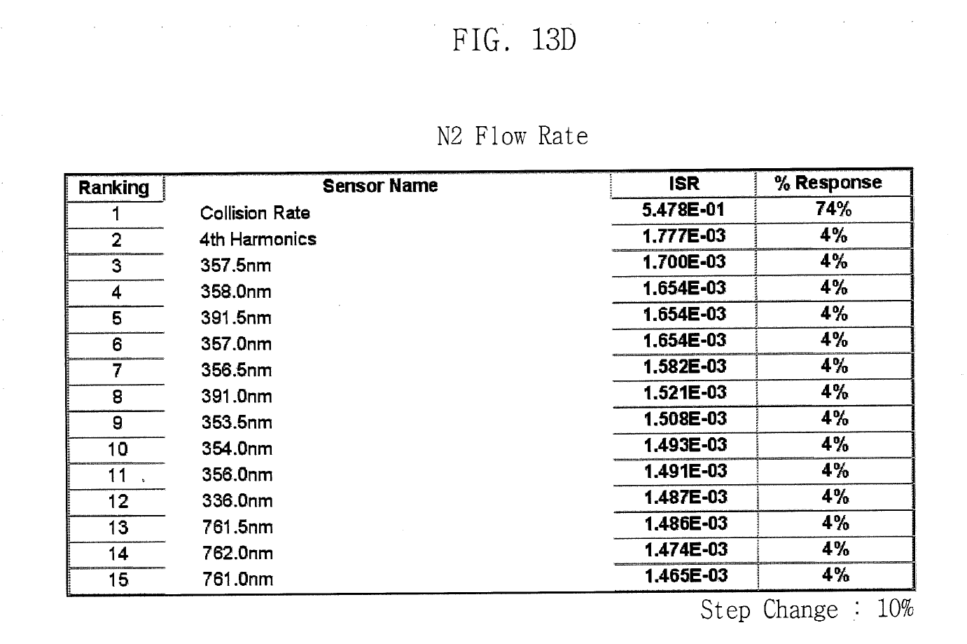

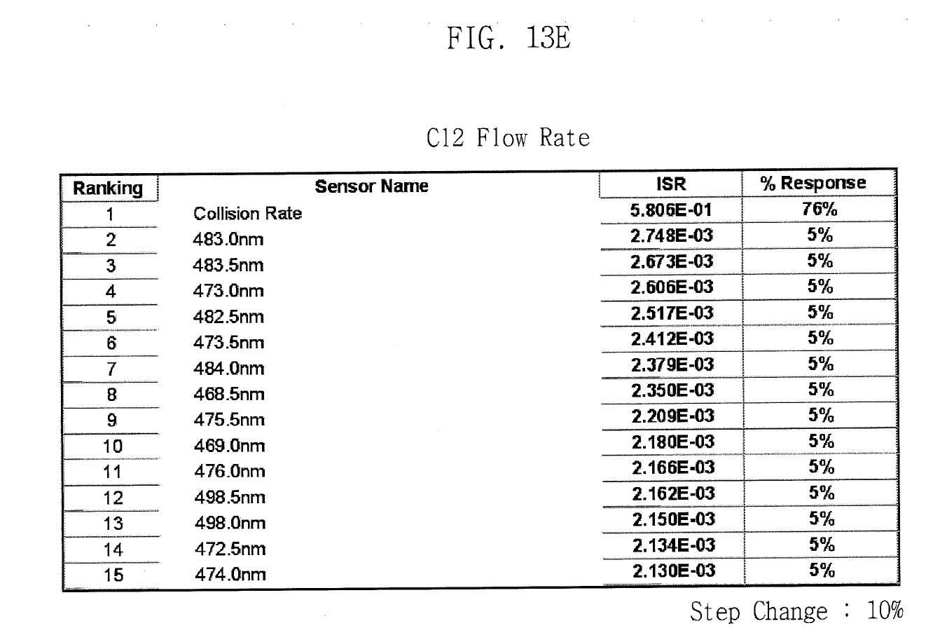

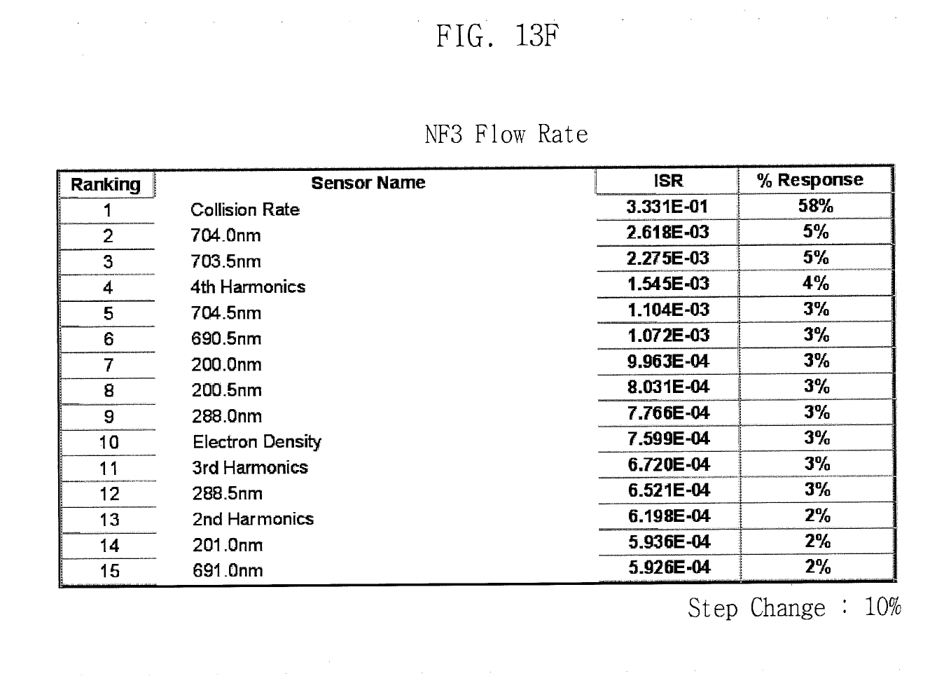

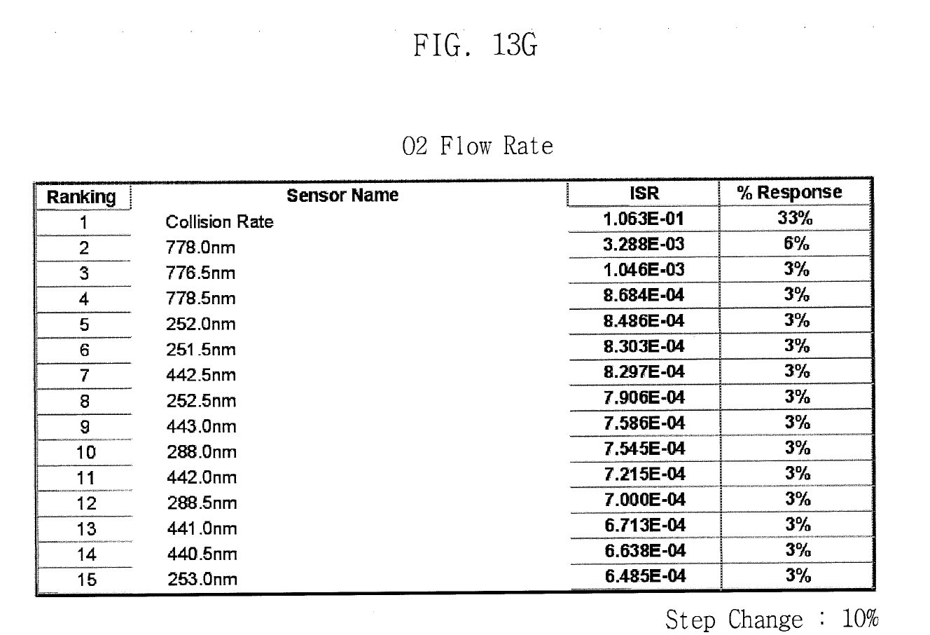

FIG. 13A-FIG. 13G are tables showing a result of arranging sensors in order of the responses for sever different process conditions that were varied.

As shown in FIG. 13A-FIG. 13G, as the process conditions such as pressure, source power, bias power, N₂ flow, Cl₂ flow, NF₃ flow, and O₂ flow are varied, it is possible to rank the sensors that have a steady state response according to each process condition using the ranking method set forth above.

It can be seen from FIG. 13A-FIG. 13G that “collision rate” is the sensor having the highest (best) response for six of the seven process conditions that are varied. This means that the “collision rate” sensor is a sensor that is suitable to detect abnormalities in the process.

Consequently, in step S320 of FIG. 17, among the sensors arranged in descending order of response for each process condition, the sensor having a highest or best response value may be selected (S320).

As shown in FIG. 13A-FIG. 13G, in some cases one sensor may be selected as the best sensor for multiple process conditions. As shown in FIG. 18, after step S320, an inquiry may be made to determine if this has occurred (S400). If it has not, the process may end (S600), and the selected sensor may be used to detect abnormalities in the process. However, if one of the selected sensors was selected as the best sensor for multiple process conditions, then operations may continue after block S400 of FIG. 18 to select another sensor having a relative gain value within a predetermined range among the sensors other than the selected sensor which can serve as an alternative sensor.

This will be described in detail.

First, the range of a reference relative gain value is set, and it is determined whether or not the selected sensor is selected for multiple process conditions (S400). The sensors other than the sensor that was selected for multiple process conditions (herein also referred to as the “repeated” sensor) are arranged in order of their respective responses according to each process condition (S510).

For example, in FIG. 13A-FIG. 13G, it can be seen that the “collision rate” sensor is the best sensor (i.e. the first-ranking sensor) for six of the seven process conditions. Thus, a sensor is also selected that may be used to replace the “collision rate” sensor for each of the six process conditions.

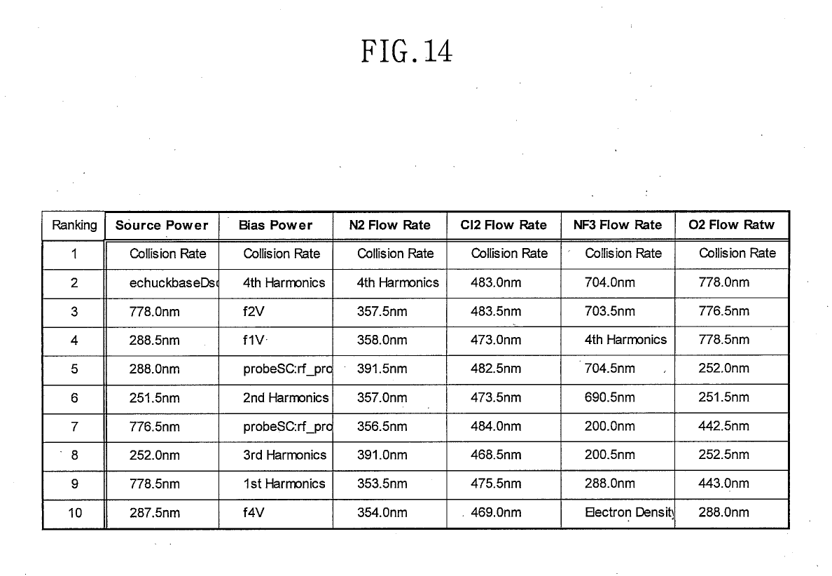

To this end, as shown in FIG. 14, ten sensors are arranged in order of their responses for each of the seven process conditions. In other words, the sensors other than the “repeated” collision rate sensor are arranged in ranked order based on their responses for each process condition.

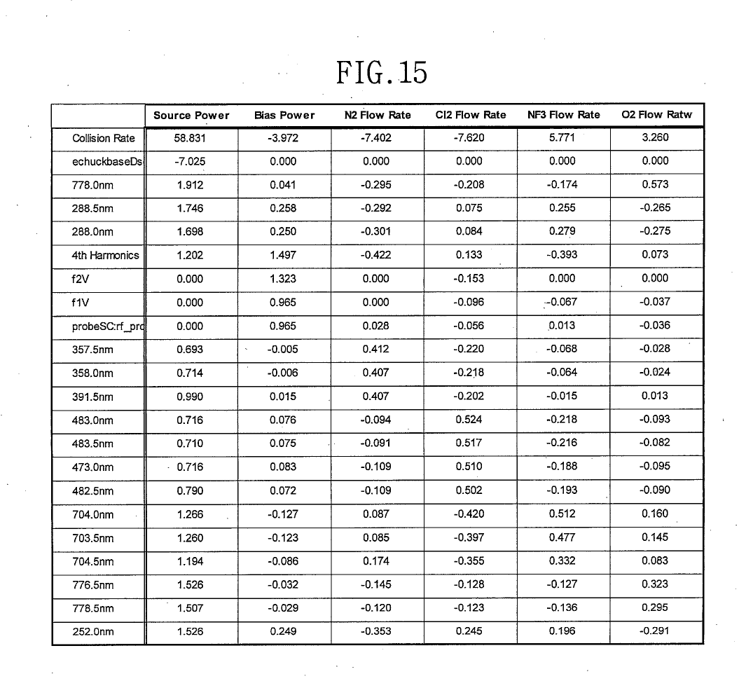

With respect to the sensors arranged in ranked order based on their responses for each process condition, a gain matrix is formed on the basis of the gain (S520). FIG. 15 shows a gain matrix fanned from the table of FIG. 14. Next, either a relative gain array (RGA) analysis or a non-square relative gain array (NRGA) analysis is performed on the gain matrix (S530), thereby calculating a relative gain value for each process condition that is varied (S540).

In order to select the alternative sensor for each process condition that is varied, the RGA analysis using a mutual analysis between process conditions (manipulated variables (MVs)) and result values (control variables (CVs)) based on the process conditions in the event of process control may be performed. The following cross references describe such an RGA analysis: E. H. Bristol, “On a New Measure of Interactions for Multivariable Process Control,” IEEE Trans. Auto. Control, AC-11, 133, 1966 and D. E. Seborg et al., “Process Dynamics and Control,” 2nd Edition, John Wiley & Sons, Inc, 2003.

When a square multiple input multiple output (MIMO) system including n MVs and n different variables is given by the following Formula (8),

Square MIMO System:

$${y}_{( s )} = {G}_{( s )} {u}_{( u )} [ \begin{matrix}{y}_{( s )} \text{:} ( n \times 1 ) Output Vector \\ {u}_{( s )} \text{:} ( n \times 1 ) Input Vector \\ {G}_{( s )} \text{:} ( n \times n ) Transfer Function Matrix\end{matrix} ] \qquad ( 8 )$$

The relative gain is given by the following Formula (9).

$${λ}_{ij} = \frac{{[ \frac{\partial {y}_{i}}{\partial {u}_{j}} ]}_{{u}_{k , k \neq j}}}{{[ \frac{\partial {y}_{i}}{\partial {u}_{j}} ]}_{{y}_{k , k \neq i}}} = \frac{open - loop\_gain}{closed - loop\_gain} \qquad ( 9 )$$

where λᵢⱼ indicates the ratio of the gain in the event of closed loop control to the gain in the event of open loop control. When the ratio is 1, this means that an input-output pair can be independently controlled.

Thus, when the input-output pair where the ratio approximates 1 is selected after the RGA of an entire system is composed of an n×n size, the input-output pair can be individually controlled while securing maximum independence.

The RGA is given by the following Formula (10).

$$\begin{matrix}Λ = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & … & {λ}_{( n - 1 ) ( n - 1 )} & {λ}_{( n - 1 ) n} \\ {λ}_{n 1} & {λ}_{n 2} & … & {λ}_{n ( n - 1 )} & {λ}_{nn}\end{matrix} \vert & ( 10 ) \\ Λ = G ⊗ {( {G}^{- 1} )}^{T} & ( 11 )\end{matrix}$$

where G is the gain matrix. The RGA, A, is given by Formula (10), and the gain matrix of n×n is calculated using Formula (11).

Further, a typical control system is a non-square system, so that it is necessary to expand the RGA into the non-square system as discussed, for example, in J. W. Chang et al, “The Relative Gain for Non-square Multivariable Systems,” Chemical Engineering Science, Vol. 45, No. 5, 1309, 1990.

The expansion of the RGA into the non-square system is allowed by applying “least-square sense” in place of the closed-loop gain under the perfect control.

With respect to the following m×n non-square system, the relative gain may be calculated using a “least-squared closed-loop gain” in place of the closed-loop control gain (such that sum of square error (SSE) is minimized).

Non-Square System:

$${y}_{( s )} = {G}_{( s )} {u}_{( u )} [ \begin{matrix}{y}_{( s )} \text{:} ( m \times 1 ) Output Vector \\ {u}_{( s )} \text{:} ( n \times 1 ) Input Vector \\ {G}_{( s )} \text{:} ( m \times n ) Transfer Function Matrix\end{matrix} ] \qquad ( 12 )$$

The relative gain and the SSE are defined by the following Formulas (13) and (14).

$$\begin{matrix}{λ}_{ij} = \frac{{[ \frac{\partial {y}_{i}}{\partial {u}_{j}} ]}_{{u}_{k , k \neq j}}}{{[ \frac{\partial {y}_{i}}{\partial {u}_{j}} ]}_{{y}_{k , k \neq i}}} = \frac{open - loop\_gain}{least - squared\_ closed - loop\_gain} & ( 13 ) \\ SSE = {\sum }_{i = 1}^{n} {‖ \overline{e} ( i ) ‖}_{2}^{2} = {\sum }_{i = 1}^{n} {‖ ( {I}_{m \times n} - {GG}_{S}^{- 1} ) {\overline{y}}_{s , i}^{set} ‖}_{2}^{2} \\ {I}_{m \times n} \text{:} m \times n matrix with unity in the diagonal zero elsewhere \\ \overline{e} \text{:} m \times 1 steady state error vector \\ {G}_{s} \text{:} transfer function of sub \text{-} sequare system \\ {\overline{y}}_{s , i}^{set} \text{:} n \times 1 vector with unity in the ith entry and zero elsewhere & ( 14 )\end{matrix}$$

This is the same concept as the RGA, but introduces the “least square sense” when the closed-loop gain is calculated.

A characteristic of the NRGA is given by the following Formula (15).

$$\begin{matrix}{Λ}^{″} = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & … & {λ}_{( n - 1 ) ( n - 1 )} & {λ}_{( n - 1 ) n} \\ {λ}_{n 1} & {λ}_{n 2} & … & {λ}_{n ( n - 1 )} & {λ}_{nn}\end{matrix} \vert \begin{matrix}0 \leq rs ( 1 ) \leq 1 \\ 0 \leq rs ( 2 ) \leq 1 \\ ⋮ \\ 0 \leq rs ( m - 1 ) \leq 1 \\ 0 \leq rs ( m ) \leq 1\end{matrix} \\ cs ( j ) = 1 for all js & ( 15 ) \\ {Λ}^{″} = G ⊗ {( {G}^{+} )}^{T} & ( 16 )\end{matrix}$$

Here, G is the gain matrix, and G⁺ is the Moore-Penrose pseudo-inverse matrix of G. Further, the NRGA, Λ″, is given by Formula (15), and the gain matrix of m×n is calculated using Formula (16). In the NRGA, one of the sum of the column and the sum of the row has a value between 0 and 1, and λ is the sensor.

In other words, in comparison with the RGA, one of the sum of the column and the sum of the row has a value between 0 and 1, and an MVs-CVs pairing rule is the same.

Subsequently, again with reference to FIG. 18, it is determined whether or not the calculated relative gain value falls within the reference relative gain value range (from 0.3 to 1) (S550).

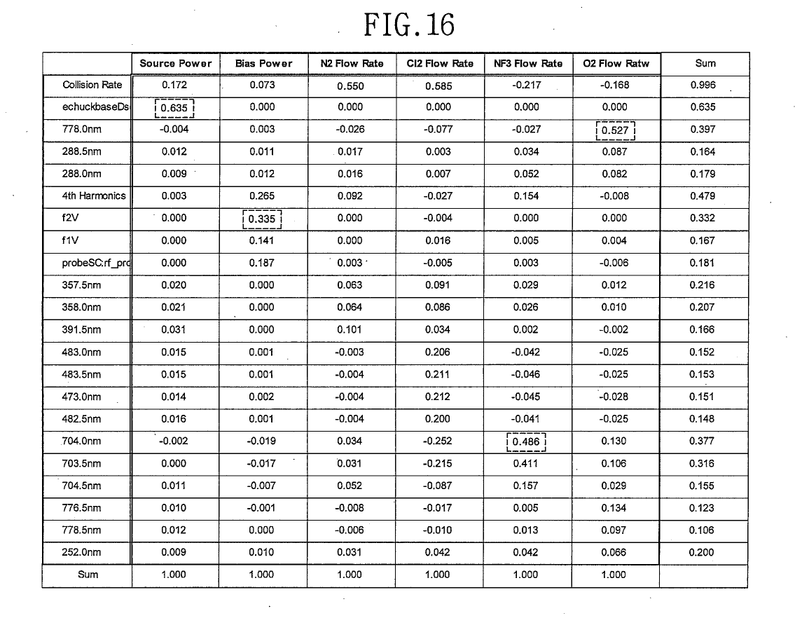

As shown in FIG. 16, the sensors in which the calculated relative gain value falls within the reference relative gain value range may be selected as alternative sensors (S560). FIG. 16 shows that alternative sensors are selected by performing a NRGA analysis of the gain matrix of FIG. 15.

If the calculated relative gain value is beyond the reference relative gain value range, a message informing “Need to Discover Sensor” may be visually represented through a display, which is not shown (S570).

As described above, when process conditions in multiple processes of manufacturing a semiconductor device are varied, a sensors having the steady state response may be selected from the plurality of sensors for detecting abnormalities in the process.

Further, when one of the sensors is selected for multiple of the process conditions that are varied, another alternate sensor may also be selected.

Also, the atmosphere where process conditions are varied in real time is configured to be accurately detected, so that the quality of a manufactured semiconductor device can be improved.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A method of selecting at least one of a plurality of sensors that are used in a semiconductor manufacturing process, the method comprising:
measuring responses of the plurality of sensors when a first of a plurality of process conditions is varied;
identifying one or more of the plurality of sensors that have a steady state response after the first of the process conditions is varied; and
selecting a sensor having the highest value within a response range from among the sensors having the steady state response for the first process condition that is varied.

2. The method according to claim 1, further comprising:
measuring responses of at least some of the plurality of sensors when additional of the plurality of process conditions are varied;
identifying ones of the plurality of sensors that have a steady state response after the additional process conditions are varied; and
selecting one of the plurality of sensors that has the highest value within a response range from among the sensors having the steady state response for each additional process condition that is varied.

3. The method according to claim 1, wherein measuring responses of the plurality of sensors when the first of the plurality of process conditions is varied comprises:
setting numerical criteria for the sensors when the first process condition is varied in order to determine the steady state response;
varying the first process condition at a predetermined level; and
measuring the response of each sensor.

4. The method according to claim 3, wherein identifying one or more of the plurality of sensors that have a steady state response after the first of the process conditions is varied comprises:
setting a signal data interval, in which signal data falls within a predetermined amplitude range, to an analysis interval, the signal data being composed of values of signals generated from the sensors with the lapse of time after the first process condition is varied;
smoothing the signal data within the analysis interval using Formula (1);
calculating smoothing values of the sensors from the smoothed signal data using Formula (2);
calculating a range of the smoothing values of the sensors from the smoothed signal data using Formula (3);
calculating numerical criteria of smoothing absolute values of the sensors from the smoothed signal data using Formula (4);
identifying the sensors in which the range of the smoothing values is less than the numerical criteria as the sensors having the steady state response; and
arranging the identified sensors in descending order of the responses for the first process condition, where Formulas (1), (2), (3) and (4) are as follows:
$${y}_{i , n} = \frac{( {x}_{i , n + 2} + {x}_{i , n + 1} + {x}_{i , n} )}{3} \qquad ( 1 )$$
where, x_{i,n} is a signal value of the i^{th} sensor at a point in time n, and y_{i,n} is an averaged signal value of the i^{th} sensor,
$$\begin{matrix}{y}_{i} = \{ {y}_{m} , … , {y}_{m} \} & ( 2 ) \\ {Range}_{i} = Max ( {Y}_{i} ) - Min ( {Y}_{i} ) & ( 3 ) \\ Numerical {Criteria}_{i} = \vert {\sum }_{j}^{n} \frac{{y}_{j}}{n} \vert \times ( \% xdev . ) & ( 4 )\end{matrix}$$
where, % xdev. is the constant.

5. The method according to claim 4, wherein arranging the identified sensors in descending order of the responses for the first process condition comprises:
calculating the signal data into a standardized value [symbol] using Formula (5);
calculating integrated square response (ISR) within an interval where the first process condition is varied using Formula (6) with respect to a standardized signal value just before the first process condition is varied; and
calculating the response and the gain using Formula (7) to arrange the selected sensors in descending order of the responses for the first process condition, where Formulas (5), (6) and (7) are as follows:
$${y}^{*} = \frac{( {y}_{+} ( t ) - {y}_{ss} )}{{y}_{ss}} \qquad ( 5 )$$
where, yₛₛ, is an average value of the signal values just before the first process condition is varied, and y₊(t) is a signal value after the first process condition is varied,
$$ISR = \frac{1}{b - a} {\int }_{a}^{b} {( {y}^{*} ( t ) )}^{2} d t \qquad ( 6 )$$
where, a is the time when the variation of the first process condition is started, and b is the time when the variation of the first process condition is completed.
$$Response ( \% ) = \sqrt{ISR} \times 100 , \\ \% Gain = \frac{Response ( \% )}{Step Change ( \% )} \qquad ( 7 )$$
where, Step Change is the variation in the first process condition.

6. The method according to claim 5, wherein selecting a sensor having the highest value within a response range from among the sensors having the steady state response for the first process condition that is varied comprises selecting a sensor having the highest value within the response range from among the sensors arranged in descending order of the responses for the first process condition.

7. The method according to claim 2, further comprising, after the sensors are selected for the first and each additional processing condition, selecting another sensor having a relative gain value within a predetermined range from among the sensors other than the selected sensor as an alternative sensor for each process condition for which the selected sensor was also selected for additional process conditions.

8. The method according to claim 7, wherein selecting the alternative sensor comprises:
setting a range of a reference relative gain value;
determining whether or not the selected sensor is selected for the multiple process conditions and, if so;
arranging the sensors other than the sensor that was selected for multiple process conditions in order of their responses for each process condition;
forming a gain matrix based on the gain with respect to the sensors arranged in order of their responses for each process condition;
performing one of a relative gain array (RGA) analysis and a non-square relative gain array (NRGA) analysis with respect to the gain matrix to calculate a relative gain value;
determining whether or not the calculated relative gain value falls within the reference relative gain value range; and
selecting the sensors in which the calculated relative gain value falls within the reference relative gain value range as the alternative sensors.

9. The method according to claim 8, wherein:
the relative gain array (Λ) is given by Formula (10), and the gain matrix of n×n is calculated using Formula (11);
the non-square relative gain array (Λ″) is given by Formula (15), and the gain matrix of m×n is calculated using Formula (16); and
in the non-square relative gain array, one of sums of a column and a row has a value between 0 and 1, and λ is the sensor, where Formulas (10), (11), (15) and (16) are as follows
$$\begin{matrix}Λ = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & … & {λ}_{( n - 1 ) ( n - 1 )} & {λ}_{( n - 1 ) n} \\ {λ}_{n 1} & {λ}_{n 2} & … & {λ}_{n ( n - 1 )} & {λ}_{nn}\end{matrix} \vert & ( 10 ) \\ Λ = G ⊗ {( {G}^{- 1} )}^{T} & ( 11 )\end{matrix}$$
where, G is the gain matrix,
$$\begin{matrix}{Λ}^{″} = \vert \begin{matrix}{λ}_{11} & {λ}_{12} & ⋯ & {λ}_{1 ( n - 1 )} & {λ}_{1 n} \\ {λ}_{21} & {λ}_{22} & ⋯ & {λ}_{2 ( n - 1 )} & {λ}_{2 n} \\ ⋮ & ⋮ & ⋱ & ⋮ & ⋮ \\ {λ}_{( n - 1 ) 1} & {λ}_{( n - 1 ) 2} & … & {λ}_{( n - 1 ) ( n - 1 )} & {λ}_{( n - 1 ) n} \\ {λ}_{n 1} & {λ}_{n 2} & … & {λ}_{n ( n - 1 )} & {λ}_{nn}\end{matrix} \vert \begin{matrix}0 \leq rs ( 1 ) \leq 1 \\ 0 \leq rs ( 2 ) \leq 1 \\ ⋮ \\ 0 \leq rs ( m - 1 ) \leq 1 \\ 0 \leq rs ( m ) \leq 1\end{matrix} \\ cs ( j ) = 1 for all js & ( 15 ) \\ {Λ}^{″} = G ⊗ {( {G}^{+} )}^{T} & ( 16 )\end{matrix}$$
where, G is the gain matrix, and G⁺ is the Moore-Penrose pseudo-inverse matrix of G.
